(19) United States
(12) Patent Application Publication
(10) Pub. No.: US 2017/0222769 A1
(43) Pub. Date: Aug. 3, 2017

(54) APPARATUS, METHOD, AND COMPUTER READABLE MEDIUM FOR TRANSMITTING A HIGH-EFFICIENCY WIRELESS LOCAL-AREA NETWORK SIGNAL FIELD FOR SMALL AND LARGE BANDWIDTH ALLOCATIONS

(71) Applicant: Intel IP Corporation, Santa Clara, CA (US)

(72) Inventors: Qinghua Li, San Ramon, CA (US); Xiaogang Chen, Hillsboro, OR (US); Yuan Zhu, Beijing (CN); Robert J. Stacey, Portland, OR (US); Huaning Niu, Milpitas, CA (US)

(21) Appl. No.: 15/329,752

(22) PCT Filed: Jun. 26, 2015
(86) PCT No.: PCT/US15/37985

§ 371 Date: Jan. 27, 2017

Related U.S. Application Data
(60) Provisional application No. 62/042,116, filed on Aug. 26, 2014.
(60) Provisional application No. 62/072,251, filed on Oct. 29, 2014.

(51) Int. Cl. H04L 5/00; H04W 72/04; H04B 7/06

(52) U.S. Cl. CPC H04L 5/0007; H04B 7/0617; H04L 5/0048; H04W 72/044; H04L 5/0025; H04W 84/12

(57) ABSTRACT

Apparatuses, methods, and computer readable media for transmitting a high-efficiency signal (HE-SIG) field for small and large bandwidth allocations are disclosed. An apparatus for a high-efficiency wireless local-area network (HEW) master station is disclosed. The apparatus may include circuitry configured to transmit a high-efficiency (HE) signal (SIG) A (HE-SIG-A) field comprising common information to a plurality of HEW stations, wherein the HE-SIG-A is to be transmitted within a first sub-channel; and transmit a HE long-training field (HE-LTF) and a HE-SIG-B to a first HEW station of the plurality of HEW stations, wherein the HE-LTF and the HE-SIG-B are to be interleaved on subcarriers of a second sub-channel, wherein the HE-SIG-B comprises a first portion of station specific information for the first HEW station, and where the HE-LTF and the HE-SIG-B are to be transmitted in accordance with beam-forming within the second sub-channel in accordance with orthogonal frequency division multi-access (OFF-DMA).

### PRIORITY CLAIM

This application claims the benefit of priority to U.S. Provisional Patent Application Ser. No. 62/072,251, filed Oct. 29, 2014, and U.S. Provisional Patent Application Ser. No. 62/042,116, filed Aug. 26, 2014, both of which are incorporated herein by reference in their entirety.

### TECHNICAL FIELD

Embodiments pertain to wireless networks. Some embodiments relate to wireless local area networks (WLANs) and networks operating in accordance with the IEEE 802.11 family of standards, such as the IEEE 802.11ac standard or the IEEE 802.11ax. Some embodiments relate to transmitting a high-efficiency signal field for small or large allocations.

### BACKGROUND

One issue in wireless local area networks (WLANs) is efficiently using the wireless network. Additionally, the wireless network may support different protocols including legacy protocols.

Thus, there are general needs for systems and methods for efficiently using the wireless medium, and in particularly, for transmitting a high-efficiency wireless local-area network signal field for small and large bandwidth allocations.

### BRIEF DESCRIPTION OF THE DRAWINGS

The present disclosure is illustrated by way of example and not limitation in the figures of the accompanying drawings, in which like references indicate similar elements and in which:

FIG. 1 illustrates a wireless network in accordance with some embodiments;

FIG. 2 illustrates a method for transmitting a HEW signal (HEW-SIG) field in accordance with some embodiments;

FIG. 3 illustrates a method for transmitting a HEW-SIG field in accordance with some embodiments;

FIG. 4 illustrates a method for transmitting HEW-SIG fields in accordance with some embodiments;

FIGS. 5 and 6 illustrate the subcarriers of the HE-LTF of different spatial streams and the subcarriers of the HE-SIG-Bs interleaved;

FIG. 7 illustrates a method for transmitting HEW-SIG fields in accordance with some embodiments;

FIG. 8 illustrates a method for transmitting HEW-SIG fields in accordance with some embodiments;

FIG. 9 illustrates packet error rates (PERs) of HE-SIG-B and short data packets in accordance with some embodiments;

FIG. 10 illustrates PERs of HE-SIG-B and short data packets in accordance with some embodiments; and

FIG. 11 illustrates a HEW device in accordance with some embodiments.

### DETAILED DESCRIPTION

The following description and the drawings sufficiently illustrate specific embodiments to enable those skilled in the art to practice them. Other embodiments may incorporate structural, logical, electrical, process, and other changes. Portions and features of some embodiments may be included in, or substituted for, those of other embodiments. Embodiments set forth in the claims encompass all available equivalents of those claims.

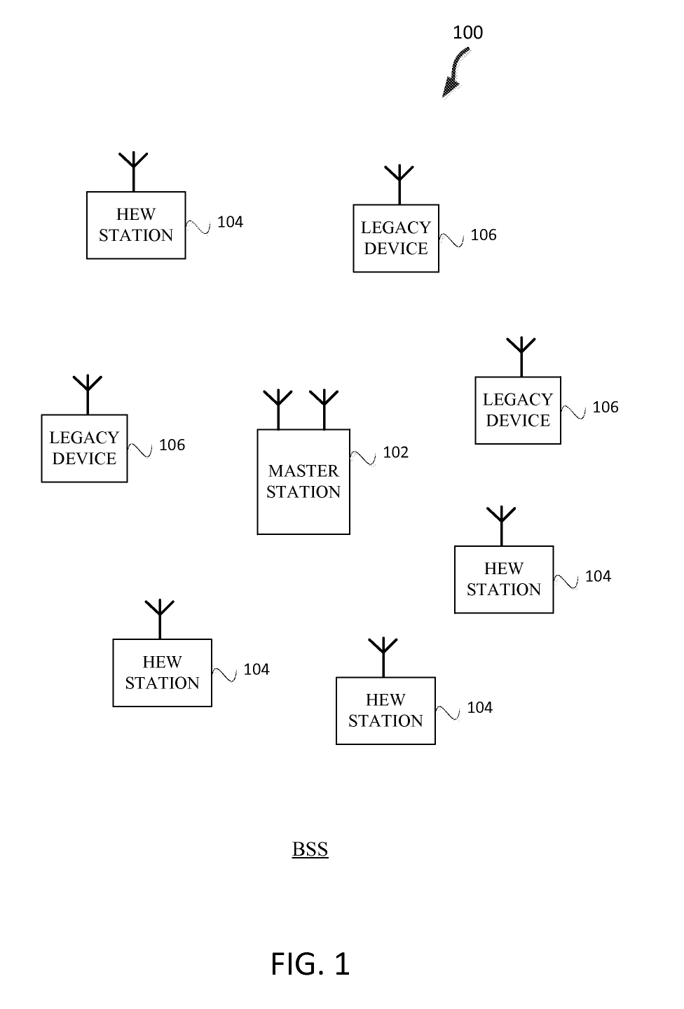

FIG. 1 illustrates a WLAN 100 in accordance with some embodiments. The WLAN may comprise a basis service set (BSS) 100 that may include a master station 102, which may be an AP, a plurality of high-efficiency wireless (HEW) (e.g., IEEE 802.11ax) STAs 104 and a plurality of legacy (e.g., IEEE 802.11n/ac) devices 106.

The master station 102 may be an AP using the IEEE 802.11 to transmit and receive. The master station 102 may be a base station. The master station 102 may use other communications protocols as well as the IEEE 802.11 protocol. The IEEE 802.11 protocol may be IEEE 802.11ax. The IEEE 802.11 protocol may include using orthogonal frequency division multiple-access (OFDMA), time division multiple access (TDMA), and/or code division multiple access (CDMA). The IEEE 802.11 protocol may include a multiple access technique. For example, the IEEE 802.11 protocol may include space-division multiple access (SDMA) and/or multiple-user multiple-input multiple-output (MU-MIMO).

The legacy devices 106 may operate in accordance with one or more of IEEE 802.11a/g/ag/n/ac, or another legacy wireless communication standard. The legacy devices 106 may be STAs or IEEE STAs.

The HEW STAs 104 may be wireless transmit and receive devices such as cellular telephone, handheld wireless device, wireless glasses, wireless watch, wireless personal device, tablet, or another device that may be transmitting and receiving using the IEEE 802.11 protocol such as IEEE 802.11ax or another wireless protocol. In some embodiments, the HEW STAs 104 may be termed high efficiency (HE) stations.

The BSS 100 may operate on a primary channel and one or more secondary channels or sub-channels. The BSS 100 may include one or more master stations 102. In accordance with some embodiments, the master station 102 may communicate with one or more of the HEW devices 104 on one or more of the secondary channels or sub-channels or the primary channel. In accordance with some embodiments, the master station 102 communicates with the legacy devices 106 on the primary channel. In accordance with some embodiments, the master station 102 may be configured to communicate concurrently with one or more of the HEW STAs 104 on one or more of the secondary channels and a legacy device 106 utilizing only the primary channel and not utilizing any of the secondary channels.

The master station 102 may communicate with legacy devices 106 in accordance with legacy IEEE 802.11 communication techniques. In example embodiments, the master station 102 may also be configured to communicate with HEW STAs 104 in accordance with legacy IEEE 802.11 communication techniques. Legacy IEEE 802.11 communication techniques may refer to any IEEE 802.11 communication technique prior to IEEE 802.11ax.

In some embodiments, a HEW frame may be configurable to have the same bandwidth as a sub-channel, and the bandwidth may be one of 20 MHz, 40 MHz, or 80 MHz, 160 MHz, 320 MHz contiguous bandwidths or an 80+80 MHz (160 MHz) non-contiguous bandwidth. In some embodiments, bandwidths of 1 MHz, 1.25 MHz, 2.0 MHz, 2.5 MHz, 5 MHz and 10 MHz, or a combination thereof or another bandwidth that is less or equal to the available bandwidth, may also be used. A HEW frame may be configured for transmitting a number of spatial streams, which may be in accordance with MU-MIMO.

In some embodiments a basic allocation or resource unit may be 26 or 242 subcarriers and the channels and sub-channels may be comprised of a number of the basic resource units. In some embodiments the basic allocation or resource unit may be a different number of subcarriers such as 24 to 256. In some embodiments there may be one or more left over subcarriers in a channel or sub-channel in addition to a number of the basic resource units.

In other embodiments, the master station 102, HEW STA 104, and/or legacy device 106 may also implement different technologies such as code division multiple access (CDMA) 2000, CDMA 2000 1X, CDMA 2000 Evolution-Data Optimized (EV-DO), Interim Standard 2000 (IS-2000), Interim Standard 95 (IS-95), Interim Standard 856 (IS-856), Long Term Evolution (LTE), Global System for Mobile communications (GSM), Enhanced Data rates for GSM Evolution (EDGE), GSM EDGE (GERAN), IEEE 802.16 (i.e., Worldwide Interoperability for Microwave Access (WiMAX)), BlueTooth®, or other technologies.

Some embodiments relate to HEW communications. In accordance with some IEEE 802.11ax embodiments, a master station 102 may operate as a master station which may be arranged to contend for a wireless medium (e.g., during a contention period) to receive exclusive control of the medium for an HEW control period. In some embodiments, the HEW control period may be termed a transmission opportunity (TXOP). The master station 102 may transmit a HEW master-sync transmission, which may be a trigger frame or HEW control and schedule transmission, at the beginning of the HEW control period. The master station 102 may transmit a time duration of the TXOP and sub-channel information. During the HEW control period, HEW STAs 104 may communicate with the master station 102 in accordance with a non-contention based multiple access technique such as OFDMA or MU-MIMO. This is unlike conventional WLAN communications in which devices communicate in accordance with a contention-based communication technique, rather than a multiple access technique. During the HEW control period, the master station 102 may communicate with HEW stations 104 using one or more HEW frames. During the HEW control period, the HEW STAs 104 may operate on a sub-channel smaller than the operating range of the master station 102. During the HEW control period, legacy stations refrain from communicating. In accordance with some embodiments, during the master-sync transmission the HEW STAs 104 may contend for the wireless medium with the legacy devices 106 being excluded from contending for the wireless medium during the master-sync transmission.

In some embodiments, the multiple-access technique used during the HEW control period may be a scheduled OFDMA technique, although this is not a requirement. In some embodiments, the multiple access technique may be a time-division multiple access (TDMA) technique or a frequency division multiple access (FDMA) technique. In some embodiments, the multiple access technique may be a space-division multiple access (SDMA) technique.

The master station 102 may also communicate with legacy stations 106 and/or HEW stations 104 in accordance with legacy IEEE 802.11 communication techniques. In some embodiments, the master station 102 may also be configurable to communicate with HEW stations 104 outside the HEW control period in accordance with legacy IEEE 802.11 communication techniques, although this is not a requirement.

In example embodiments, the HEW device and/or the master station 102 are configured to perform the methods and functions described in conjunction with FIGS. 1-11.

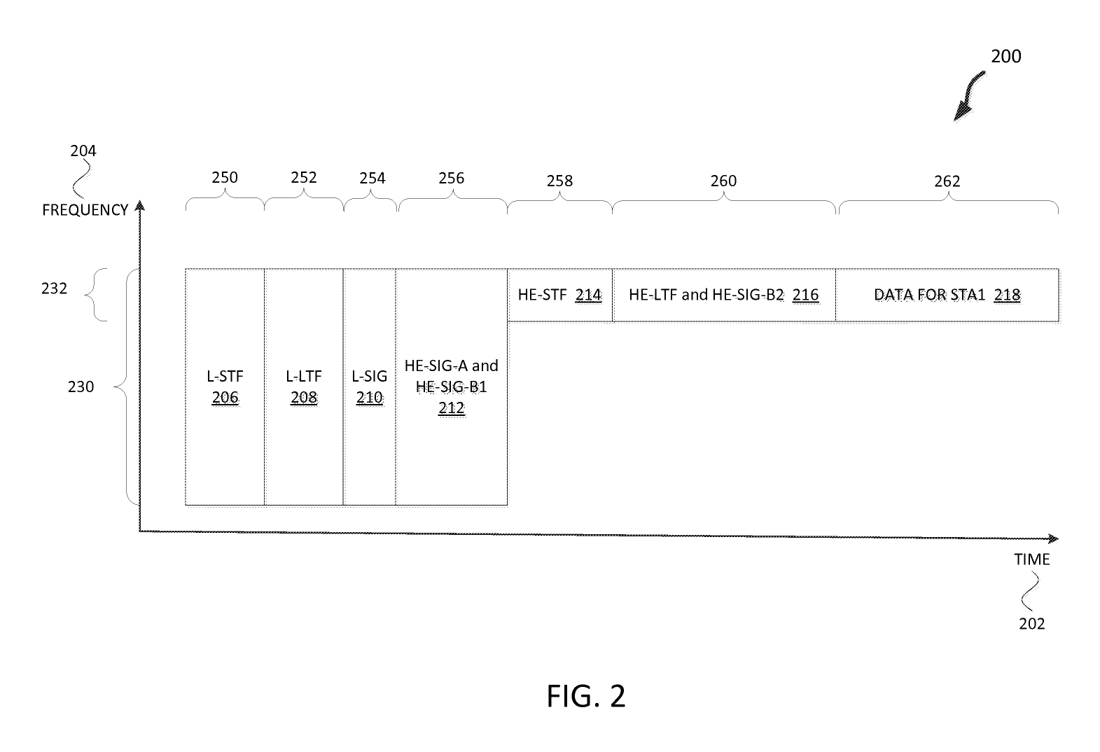

FIG. 2 illustrates a method 200 for transmitting a HEW signal (HEW-SIG) field in accordance with some embodiments. Illustrated in FIG. 2 are time 202 along a horizontal axis, frequency 204 along a vertical axis, first sub-channel 230, and second sub-channel 232.

First sub-channel 230 may be a portion of a bandwidth of the frequency. The first sub-channel 230 may be 10, 20, 40, 80, 160, 320 MHz or another portion of the bandwidth. The second sub-channel 232 may be 2.5, 5.0, 10 MHz or another portion of the bandwidth. In some embodiments, the first sub-channel 230 may be considered a large allocation. In some embodiments, the second sub-channel 232 may be considered a small allocation. The second sub-channel 232 may be a portion of the first sub-channel 230 in accordance with some embodiments. STA1 may be a HEW master station 102 or HEW station 104.

Operations 250, 252, and 254 are optional. A master station which may be a HEW master station 102 and/or a HEW station 104 performs the operations 250, 252, 254, 258, 260, 262 of the method 200. The method 200 begins at operation 250 with transmit legacy short-training field (L-STF) 206. The L-STF 206 may be a legacy signal field that describes the data rate and length of the frame. The frame may include legacy short-training field (L-STF) 206, long training field (L-LTF) 208, legacy signal field (L-SIG) 210, high efficiency signal A (HE-SIG-A) and high efficiency signal B1 (HE-SIG-B1) 212, high efficiency short-training field (HE-STF) 214, high-efficiency long-training field (HE-LTF) and high-efficiency signal B2 (HE-SIG-B2) 216, and data for STA1 216.

The method 200 continues at operation 252 with transmitting L-LTF 208. The L-LTF 208 may be symbols that set up demodulation of the frame. The method 200 continues at operation 254 with transmitting L-SIG 210. The L-SIG 210 may a legacy signal field.

The method 200 continues at operation 256 with transmitting HE-SIG-A and HE-SIG-B1 212. The SIG-A and HE-SIG-B1 212 may be transmitted on the first sub-channel 230. The SIG-A and HE-SIG-B1 212 may be transmitted to a multiple stations including STA1. The HE-SIG-A and HE-SIG-B1 212 may be one symbol. The HE-SIG-A may be common information regarding the packet that is common for STAs including STA1 that may be participating in a transmission opportunity.

The common information may include one or more of the following: a group identification that identifies one or more groups of HEW stations 104 that are allocated a sub-channel, a number of spatial streams, a duration of a physical frame comprising the HE-LTF and a HE-SIG-B, an indication of a partition of the first sub-channel 330 into a number of second sub-channels 332, an indication of a bandwidth of the second sub-channel 332, and an indication that the communication protocol of the packet is IEEE 802.11ax. The transmission opportunity may be a downlink transmission opportunity.

The HE-SIG-B1 and HE-SIG-B2 may include station specific information that is specific to STA1 such as the identification (ID) of STA1, a sub-channel 232, a modulation and coding scheme (MCS), a number of spatial streams for STA1, a diversity scheme type, and/or a duration of the physical frame. HE-SIG-B1 and HE-SIG-B2 may require 14-16 bits for a single stream mode and 21 bits for a multiple stream mode. HE-LTF and HE-SIG-B2 216 may not have enough space to include the information all the information specific to STA1 so some of the information may be included in HE-SIG-B1. HE-SIG-B1 may include information specific for STA1 such one or more of the following: an ID address of STA1, modulation and coding scheme used for the data for STA1, the number of spatial streams, and a diversity scheme type. The HE-SIG-A and HE-SIG-B1 212 may include specific information for other stations.

If the partial ID or association ID of STA1, is transmitted before HE-STF 214, then a resource map may need to be included within the HE-SIG-A and HE-SIG-B1 212 so that STA1 can determine its sub-channel, e.g. that HE-STF 214 will be transmitted on second sub-channel 232. Since the added resource map causes overhead such as ten bits per STA ID in the resource map, the MCS of the HE-SIG-B1 instead of an ID for STA1 is shifted to HE-SIG-B1 and the ID for STA1 is kept in HE-SIG-B2.

The first sub-channel 230 may be a primary sub-channel. The HE-SIG-A and HE-SIG-B1 212 may be transmitted using beamforming or not using beamforming. The method 200 continues at operation 258 with transmitting a HE HE-STF 214. The HE-STF 214 may include symbols that set up demodulation of HE-LTF and HE-SIG-B2 216, and data for STA1 216. The HE-STF 214 may be transmitted using beam forming to STA1.

The method 200 continues at operation 260 with transmitting HE-LTF and HE-SIG-B2 216. HE-LTF and HE-SIG-B2 216 may be transmitted using beamforming to STA1. HE-LTF may be training signals for STA1 to receive HE-LTF and HE-SIG-B2 216, and data for STA1 218. In some embodiments HE-LTF and HE-SIG-B2 216 may be transmitted on subcarriers with the subcarriers interleaved. The method 200 continues at operation 262 with transmitting data for STA1 218. The data may be downlink data from a master station 102 to a HEW station 104. The data for STA1 218 may be transmitted using beam forming. Each operation 250, 252, 254, 256, 258, 260, 262 may be transmitted in accordance with OFDMA.

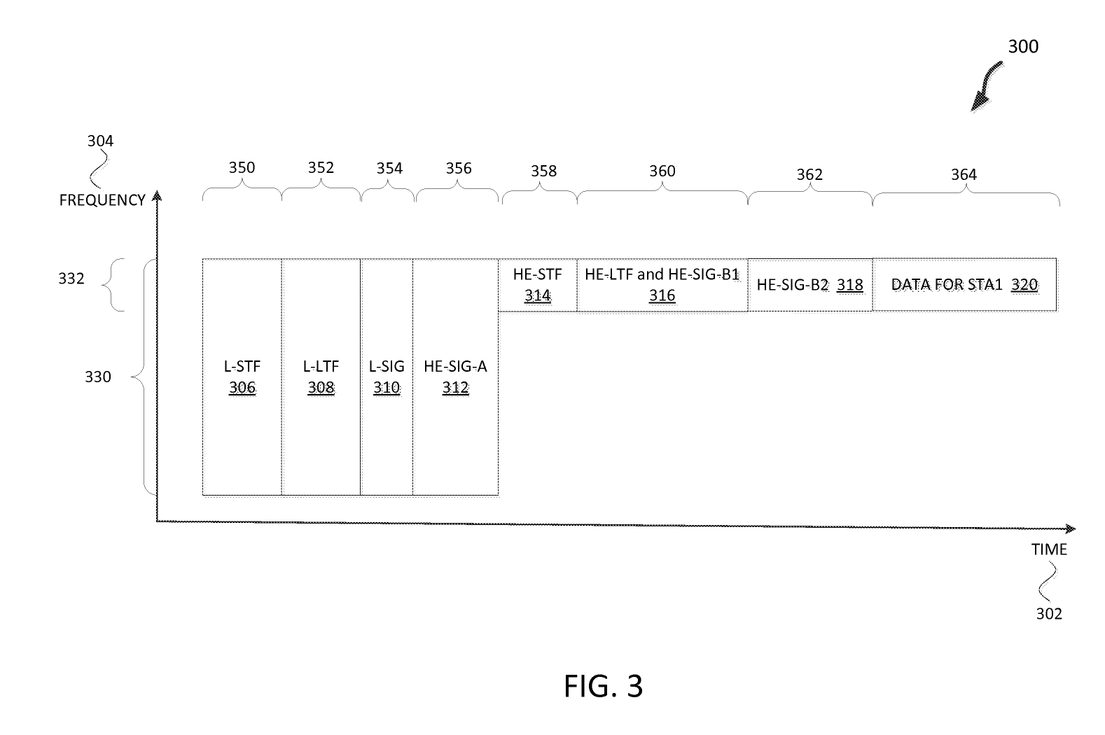

FIG. 3 illustrates a method 300 for transmitting a HEW-SIG field in accordance with some embodiments. Illustrated in FIG. 3 are time 302 along a horizontal axis, frequency 304 along a vertical axis, first sub-channel 330, and second sub-channel 332.

First sub-channel 330 may be a portion of a bandwidth of the frequency. The first sub-channel 330 may be 10, 20, 40, 80, 160, 320 MHz, or another portion of the bandwidth. The second sub-channel 332 may be 2.5, 5.0, 10 MHz or another portion of the bandwidth. In some embodiments, the first sub-channel 330 may be considered a large allocation. In some embodiments, the second sub-channel 332 may be considered a small allocation. STA1 may be a HEW master station 102 or HEW station 104. The second sub-channel 332 may be a portion of the first sub-channel 330 in accordance with some embodiments. STA1 may be a HEW master station 102 or HEW station 104.

Operations 350, 352, and 354 are optional. A master station which may be a HEW master station 102 and/or a HEW station 104 performs the operations 350, 352, 354, 358, 360, 362, and 364 of the method 300. Operations 350, 352, and 354 may be similar to or the same as the corresponding operations 250, 252, 254, described in conjunction with method 200. In method 300 user specific information that may be called HE-SIG-B 318 is transmitted after HE-STF 314 over two OFDMA symbols.

The method 300 begins at operation 350 with transmit legacy short-training field (L-STF) 306. The method 300 continues at operation 352 with transmitting L-LTF 308. The method 300 continues at operation 354 with transmitting L-SIG 310.

The method 300 continues at operation 356 with transmitting HE-SIG-A 312. The SIG-A 312 may be transmitted on the first sub-channel 330. The SIG-A 312 may be transmitted to multiple stations including STA1. The HE-SIG-A 312 may be one symbol such as an OFDMA symbol. The HE-SIG-A may be information common for STAs including STA1 that may be participating in a transmission opportunity. The transmission opportunity may be a downlink transmission opportunity.

The method 300 continues at operation 358 with transmitting HE-STF 314. Operation 358 may be the same or similar to operation 258 described in conjunction with FIG. 2.

The method 300 continues at operation 360 with transmitting HE-LTF and HE-SIG-B1 316. The method 300 continues at operation 360 with transmitting HE-LTF and HE-SIG-B1 316. HE-LTF and HE-SIG-B1 316 may be transmitted using beamforming to STA1. HE-LTF may be training signals for STA1 to receive HE-LTF and HE-SIG-B1 316, HE-SIG-B2 318, and data for STA1 320. In some embodiments HE-LTF and HE-SIG-B1 316 may be transmitted on subcarriers with the subcarriers interleaved. HE-SIG-B1 and HE-SIG-B2 318 may be STA1 specific information that is separated. HE-LTF and HE-SIG-B1 316 may be transmitted using beamforming.

The method 300 continues at operation 362 with transmitting HE-SIG-B2 318. The HE-SIG-B2 318 may be STA1 specific information. HE-SIG-B2 318 may be transmitted using beam forming. HE-SIG-B2 318 may be one OFDMA symbol. In some embodiments, HE-SIG-B2 318 may some data signal included if there is space leftover after the STA1 specific information.

The method 300 continues at operation 364 with transmitting data for STA1 320. The data may be downlink data from a master station 102 to a HEW station 104. The data for STA1 320 may be transmitted using beam forming. Each operation 350, 352, 354, 356, 358, 360, 362, and 364 may be transmitted in accordance with OFDMA. The first sub-channel 330 may be a primary sub-channel.

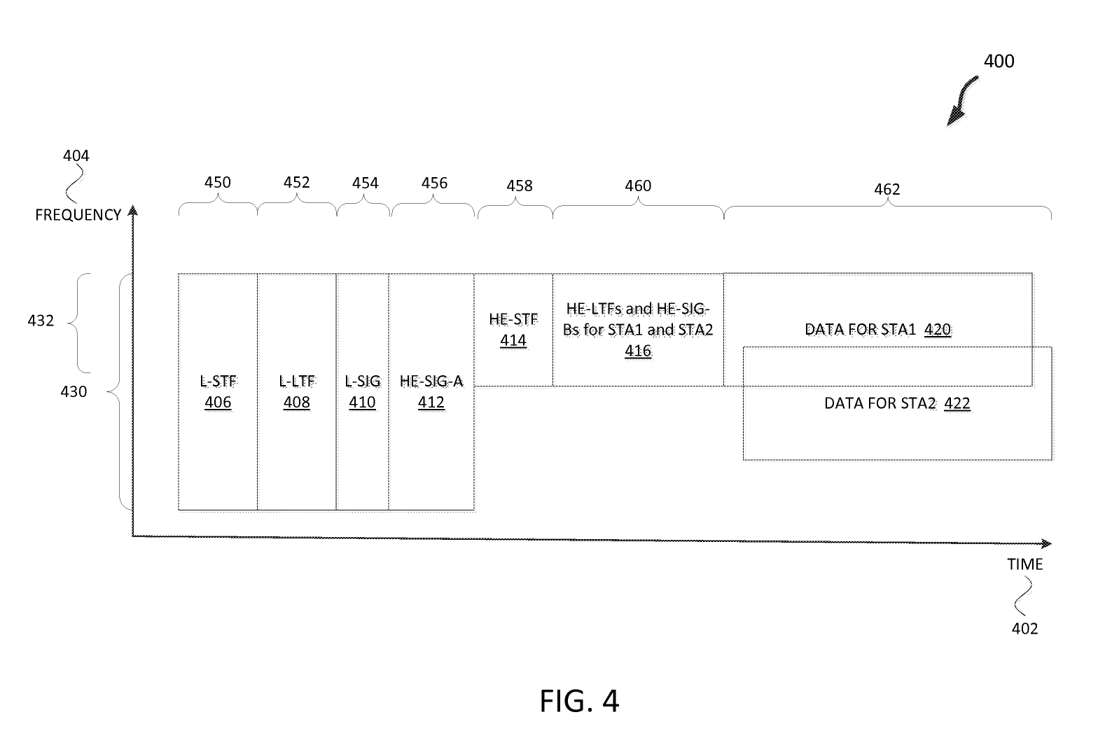

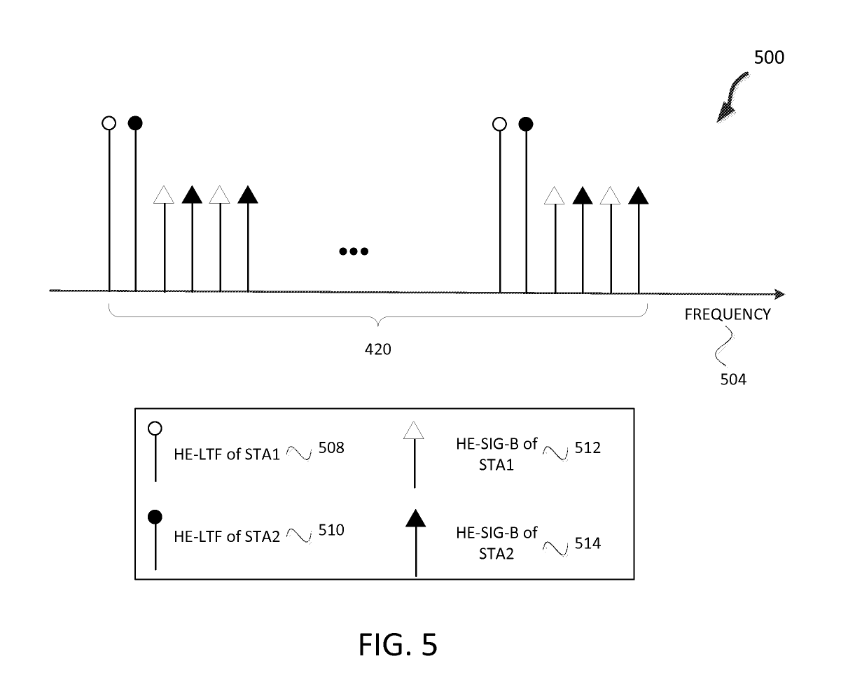

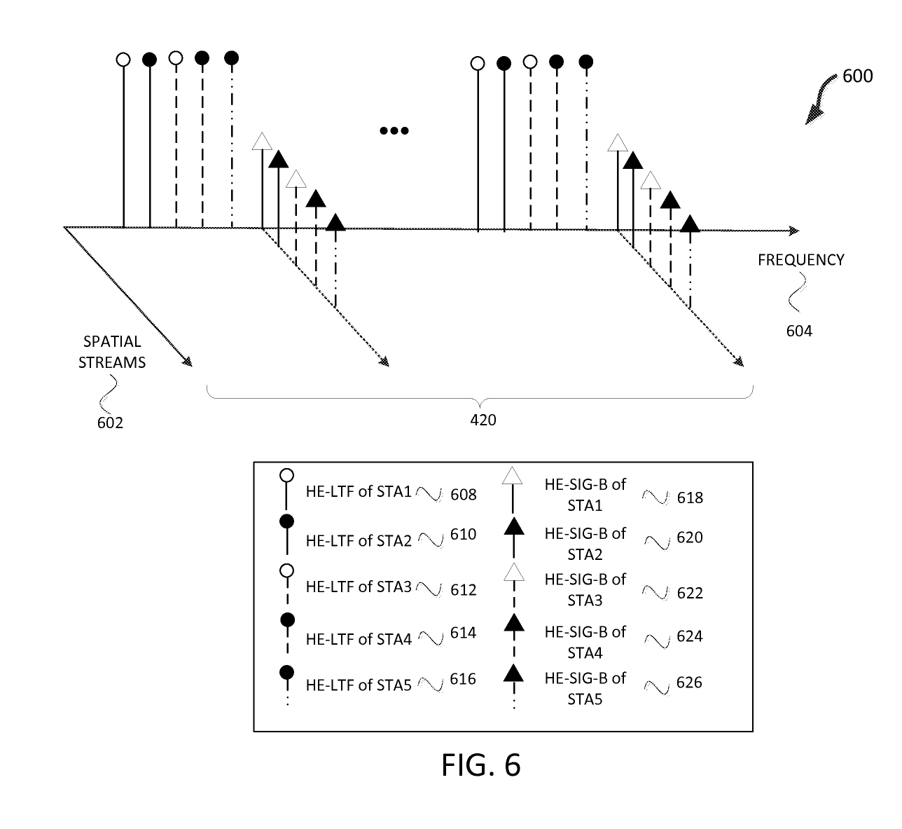

FIG. 4 illustrates a method 400 for transmitting HEW signal (HEW-SIG) fields in accordance with some embodiments. Illustrated in FIG. 4 are time 402 along a horizontal axis, frequency 404 along a vertical axis, first sub-channel 430, and second sub-channel 432. FIG. 4 will be described in conjunction with FIGS. 5 and 6.

First sub-channel 430 may be a portion of a bandwidth of the frequency. The first sub-channel 430 and second sub-channel 432 may be 10, 20, 40, 80, 160, 320 MHz or another portion of the bandwidth. In some embodiments, the first sub-channel 430 may be considered a large allocation. In some embodiments, the second sub-channel 432 may be considered a large allocation. The second sub-channel 332 may be a portion of the first sub-channel 330 in accordance with some embodiments. STA1 and STA2 may be a HEW master station 102 or HEW station 104.

Operations 450, 452, and 454 are optional. A master station 102 which may be a HEW master station and/or a HEW station 104 performs the operations 450, 452, 454, 458, 460, 462, and 464 of the method 400. Operations 450, 452, and 454 may be similar to or the same as the corresponding operations 350, 352, 354, described in conjunction with method 300 of FIG. 3.

The method 400 continues at operation 458 with transmitting HE-STF 414. Operation 458 may be the same or similar to operation 238 described in conjunction with FIG. 3. In some embodiments beamforming is not used to transmit the HE-STF 414.

The method 400 continues at operation 460 with transmitting HE-LTFs and HE-SIG-Bs for STA1 and STA2 416. A HE-LTF and a HE-SIG-B may be transmitted for each STA. The subcarriers of the HE-LTF and HE-SIG-B for STA1 and STA2 416 may be partitioned into two parts, HE-LTF subcarriers and HE-SIG subcarriers. FIGS. 5 and 6 illustrate the subcarriers of the HE-LTF of different spatial streams and the subcarriers of the HE-SIG-Bs interleaved. Illustrated in FIG. 5 is frequency 504 along a horizontal axis and interleaved HE-LTF of STA1 508, HE-LTF of STA2 510, HE-SIG-B of STA1 512, and HE-SIG-B of STA2 514. HE-LTF of STA1 508, HE-LTF of STA2 510, HE-SIG-B of STA1 512, and HE-SIG-B of STA2 514 may be interleaved in different patterns. In some embodiments STA1 and STA2 are allocated a same 10 MHz sub-channel which may be the second sub-channel 420. Sub-channel 420 may have about 120 subcarriers. STA1 may take about 20 subcarriers for HE-LTF of STA1 508 and STA2 may take about 20 subcarriers for HE-LTF of STA2 510.

The remaining 80 or so subcarriers are used for sending the HE-SIG-B of STA1 512 and HE-SIG-B of STA2 514. HE-LTF of STA1 508 and HE-LTF of STA2 510 may be distributed over the second sub-channel 420 to provide frequency diversity and so that the response of the second sub-channel 420 can be estimated more accurately. The HE-LTF of STA1 508 and HE-LTF of STA2 510 may take different subsets of the subcarriers and are interleaved with each other. In some embodiments, the HE-LTF of STA1 508 and HE-LTF of STA2 510 do not overlap in the frequency domain. The HE-SIG-B of STA1 512 and HE-SIG-B of STA2 514 may take different subsets of the subcarriers in frequency 504 domain as illustrated in FIG. 5 or may take the same subset of subcarriers in the frequency 604 domain as illustrated in FIG. 6 and use different spatial streams 602.

Illustrated in FIG. 6 is frequency 604 along a horizontal axis and spatial streams 602 along a second axis. Illustrated in FIG. 6 are five STAs. The second sub-channel 432 is illustrated as a portion of the frequency 604. The HE-LTF of STA1 608, HE-LTF of STA2 610, HE-LTF of STA3 612, HE-LTF of STA4 614, and HE-LTF of STA5 616 are interleaved. In some embodiments, the HE-LTF of STA1 608, HE-LTF of STA2 610, HE-LTF of STA3 612, HE-LTF of STA4 614, and HE-LTF of STA5 616 may be in a different pattern of interleaving. The HE-SIG-B of STA1 618, HE-SIG-B of STA2 620, HE-SIG-B of STA3 622, HE-SIG-B of STA4 624, and HE-SIG-B of STA5 626 may use the same subset of subcarriers in the frequency 604 domain and different spatial streams 602.

There may be 240 subcarriers in the second sub-channel 432. STA1, STA2, STA3, STA3, and STA5 take 40 subcarriers for HE-LTF of STA1 608, HE-LTF of STA2 610, HE-LTF of STA3 612, HE-LTF of STA4 614, and HE-LTF of STA5 616, respectively. The remaining 40 or so subcarriers are used for sending all HE-SIG-B of STA1 618, HE-SIG-B of STA2 620, HE-SIG-B of STA3 622, HE-SIG-B of STA4 624, and HE-SIG-B of STA5 626 with each using a different spatial stream 602 using spatial multiplexing. In the downlink transmission opportunity, a receiving STA learns the channel response of a spatial stream 602 from the corresponding HE-LTF subcarriers of the spatial stream. Using the channel estimates of the HE-LTF subcarriers and their interpolation on other subcarriers, the receiver STA can detect the corresponding HE-SIG-B transmitted to the receiver STA over the same spatial stream on the HE-SIG-B subcarriers.

In some embodiments, the HE-LTF of the STAs do not overlap in the frequency 604 domain. In method 400 user specific information that may be called HE-SIG-B is transmitted after HE-STF 314 over two OFDMA symbols.

The method 400 continues at operation 462 with transmitting data for STA1 420, and data for STA2 422 on different spatial streams. The spatial streams 602 (FIG. 6) may be the same spatial streams HE-SIG-Bs of the STAs are transmitted on. The master station may send the frame to more than two STAs in each operation 450, 452, 454, 456, 458, 460, 462 of method 400. The method 400 may end or may portions may be repeated. For example, the master station 102 may wait to receive acknowledgements or block acknowledgements from the STAs and then send additional data.

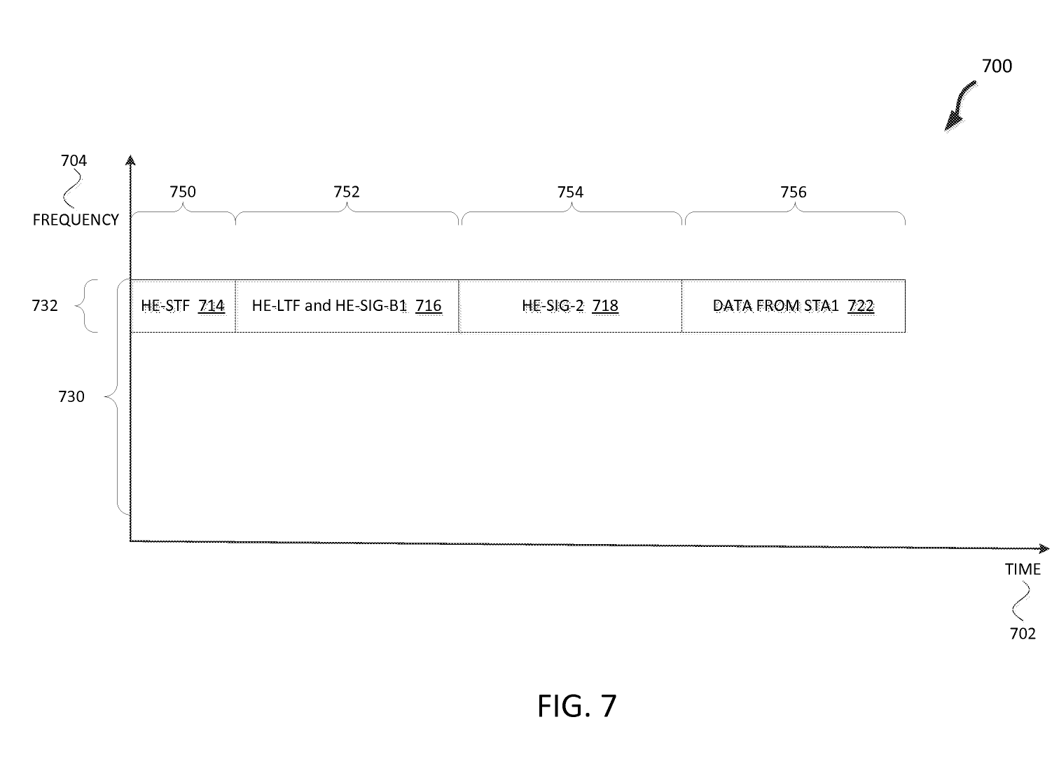

FIG. 7 illustrates a method 700 for transmitting HEW-SIG fields in accordance with some embodiments. Illustrated in FIG. 7 are time 702 along a horizontal axis, frequency 704 along a vertical axis, first sub-channel 730, and second sub-channel 732. FIG. 7 may be performed by a STAs sending information to a master station 102 or another STA. The STA may be master station 102, HEW master station, or HEW station 104.

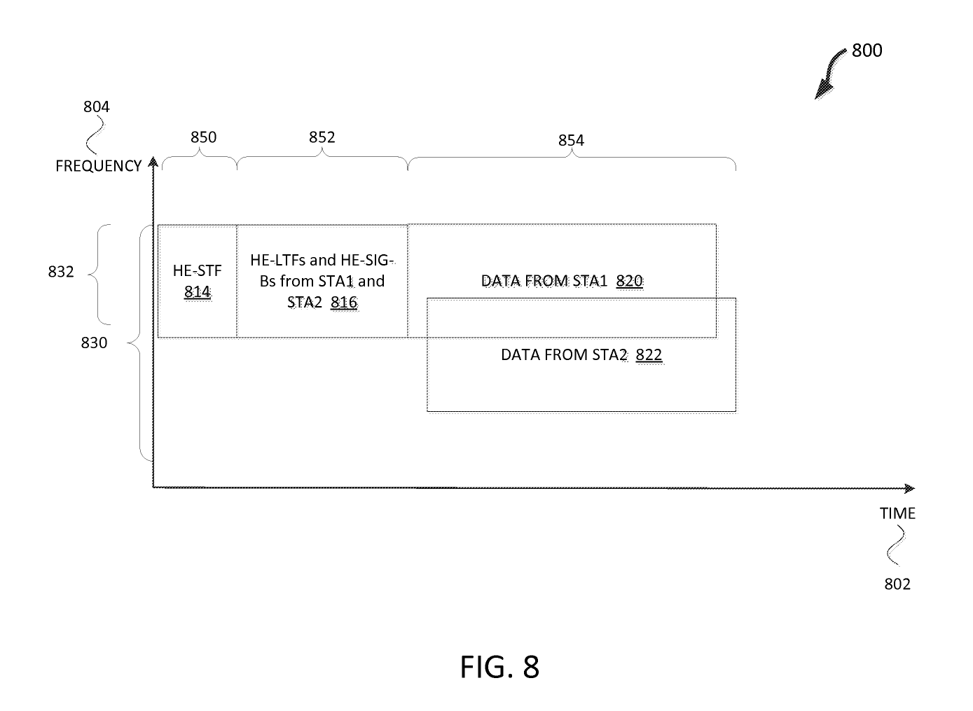

FIGS. 2-4 illustrate a downlink transmission opportunity. FIGS. 7 and 8 illustrate uplink transmission opportunities. The first sub-channel 730 may be a portion of a bandwidth of the frequency. The first sub-channel 730 may be 10, 20, 40, 80, 160, 320 MHz or another portion of the bandwidth. The second sub-channel 732 may be 2.5, 5.0, 10 MHz or another portion of the bandwidth. The STA may have already received a resource allocation from the master station that indicates that the STA is to transmit on the second sub-channel 732. In some embodiments, the master station may specify the MCS, the number of streams, and other physical layer settings for each scheduled STA.

The method 700 may start at operation 750 with transmitting a HE-STF 714. The STA may transmit HE-STF 714 using beam forming. The method 700 continues at operation 752 with transmitting HE-LTF and HE-SIG-B1 716 to the master station. The HE-LTF and HE-SIG-B1 may be multiplexed in the frequency 704 domain. The HE-LTF may be spread across the second sub-channel 732. For example, the HE-LTF and HE-SIG-B1 may be interleaved. Other patterns may be used. The STA may use beamforming to transmit HE-LTF and HE-SIG-B1 716.

The method 700 continues at operation 754 with transmitting HE-SIG-2 718. The STA may use beamforming to transmit the HE-SIG-2 718. The method 700 continues at operation 756 with transmitting data from STA1 720. The STA may use beamforming to transmit the data to the master station. The method 700 may end. In some embodiments the method 700 may continue with the STAs waiting for an acknowledgement or block acknowledgement from the master station.

FIG. 8 illustrates a method 800 for transmitting HEW-SIG fields in accordance with some embodiments. Illustrated in FIG. 8 are time 802 along a horizontal axis, frequency 804 along a vertical axis, first sub-channel 830, and second sub-channel 832. FIG. 8 may be performed by STAs sending information or a frame to a master station 102 or another STA. The STA may be master station 102, HEW master station, or HEW station 104.

The first sub-channel 830 may be a portion of a bandwidth of the frequency. The first sub-channel 830 may be 10, 20, 40, 80, 160, 320 MHz or another portion of the bandwidth. The second sub-channel 832 may be 2.5, 5.0, 10 MHz or another portion of the bandwidth. The STA may have already received a resource allocation from the master station that indicates that the STA is to transmit on the second sub-channel 832. In some embodiments, the master station may specify the MCS, the number of streams, and other physical layer settings for each scheduled STA.

The method 800 may start at operation 850 with transmitting a HE-STF 814. The STAs may each transmit a HE-STF 814 using beam forming. The method 800 continues at operation 852 with STA1 and STA2 transmitting HE-LTFs and HE-SIG-Bs. The HE-LTFs and HE-SIG-Bs may be multiplexed in the frequency 804 domain. The HE-LTFs and HE-SIG-Bs may use a pattern as described in conjunction with FIGS. 4-6. The method 800 continues at operation 854 with STA1 and STA2 transmitting data from STA1 820 and data from STA2 822. The STAs may transmit data on a spatial stream allocated to the STA as described in conjunction with FIG. 4. The method 800 may end. In some embodiments the method 800 may continue with the STAs waiting to receive acknowledgements or block acknowledgments from the master station. In some embodiments the method 800 may continue with multiple data uplinks and acknowledgements.

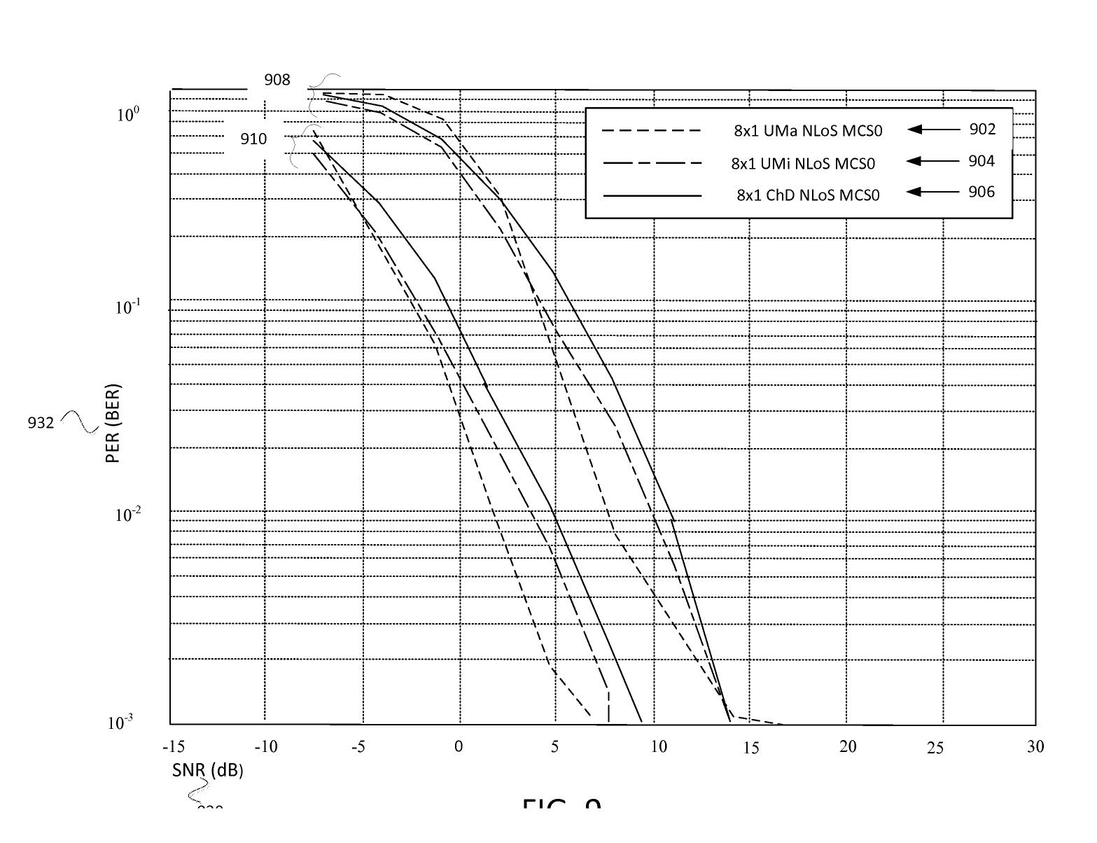

FIG. 9 illustrates packet error rates (PERs) of HE-SIG-B and short data packets in accordance with some embodiments. Illustrated in FIG. 9 is signal to noise ratio (SNR) in decibels (dB) along a horizontal axis, PERs 932 along a vertical axis, 8×1 UMa NLoS MCS0 902, 8×1 UMi NLoS MCS0 904, and 8×1 ChD NLoS MCS0 906, where 8×1 indicates 8 antennas at the master station and 1 antenna at the station; UMa indicates urban macro-cell model;

NLoS indicates non-line of sight condition; MCS0 indicates MCS0 in accordance with IEEE 802.11; and, UMi indicates International Telecommunications Union Urban Micro; ChD indicates IEEE 802.11 channel model D.

The graph illustrates the combination of HE-LTF and HE-SIG 910 PER compared with data 908 PER. The HE-LTF and HE-SIG 910 have a 15 bit payload and the data 908 has a 32 byte payload. In these simulations, one quarter of the subcarriers were used for the channel training HE-LTF and use the estimated channel to detect the HE-SIG data on the other three quarters of the subcarriers.

Three channel models were tested, 8×1 UMa NLoS MCS0 902, 8×1 UMi NLoS MCS0 904, and 8×1 ChD NLoS MCS0 906. The graph in FIG.

9 illustrates that HE-LTF and HE-SIG 910 can be reliably detected using the LTF signal in the same OFDMA symbol and that the HE-SIG detection is not the bottleneck of the data detection.

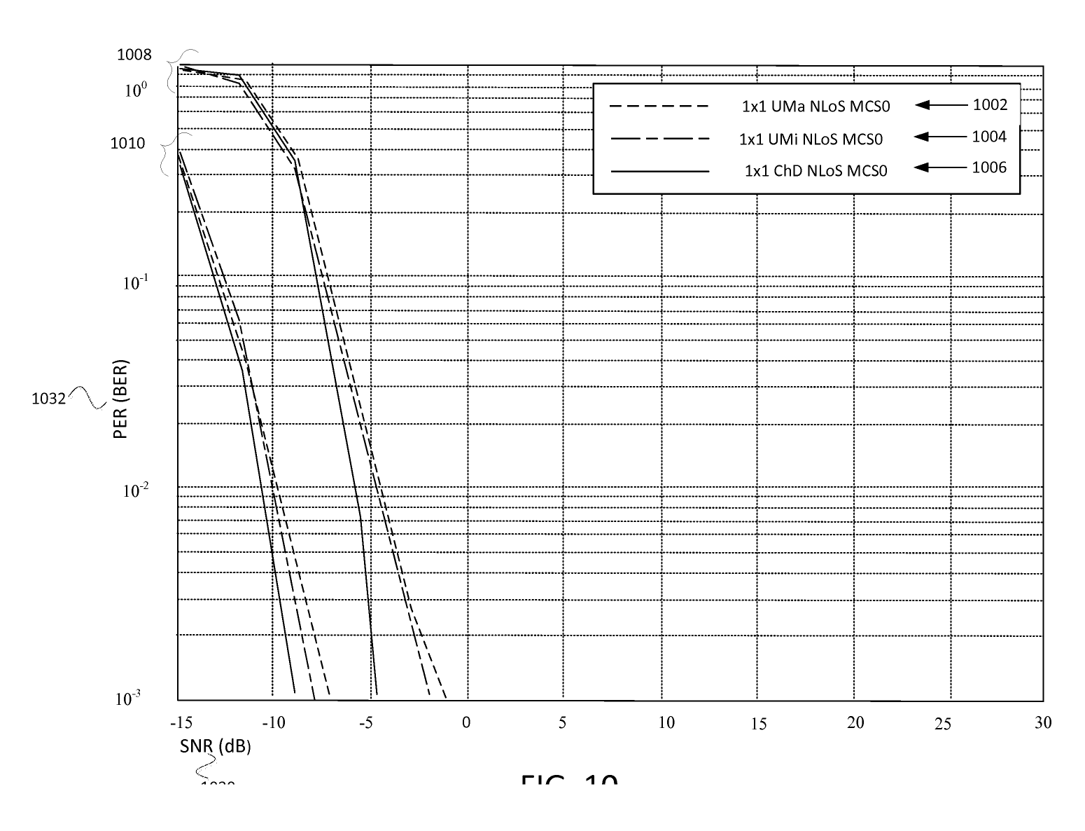

FIG. 10 illustrates PERs of HE-SIG-B and short data packets in accordance with some embodiments. Illustrated in FIG. 10 is SNR 1030 in dB along a horizontal axis, PERs 1032 along a vertical axis, 1×1 UMa NLoS MCS0 1002, 1×1UMi NLoS MCS0 1004, and 1×1ChD NLoS MCS0 1006, where 1×1indicates that the open loop case. The graph illustrates the combination of HE-LTF and HE-SIG 1010 PER compared with data 1008 PER. The HE-LTF and HE-SIG 1010 have a 15 bit payload and the data 1008 has a 32 byte payload. In these simulations, one quarter of the subcarriers were used for the channel training HE-LTF and use the estimated channel to detect the HE-SIG data on the other three quarters of the subcarriers.

Three channel models were tested, which are 1×1 UMa NLoS MCS0 1002, 1×1UMi NLoS MCS0 1004, and 1×1ChD NLoS MCS0 1006.

The graph in FIG. 10 illustrates that HE-LTF and HE-SIG 1010 can be reliably detected using the LTF signal in the same OFDMA symbol and that the HE-SIG detection is not the bottleneck of the data detection. For example, the PER 1032 is lower for the HE-LTF and HE-SIG 1010 than for the data 1008.

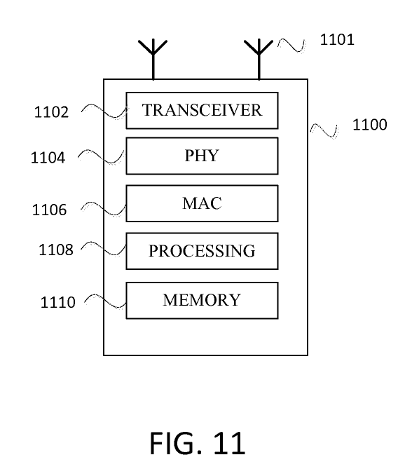

FIG. 11 illustrates a HEW device 1100 in accordance with some embodiments. HEW device 1100 may be an HEW compliant device that may be arranged to communicate with one or more other HEW devices, such as HEW STAs 104 (FIG. 1) or master station 102 (FIG. 1) as well as communicate with legacy devices 106 (FIG. 1). HEW STAs 104 and legacy devices 106 may also be referred to as HEW devices and legacy STAs, respectively. HEW device 1100 may be suitable for operating as master station 102 (FIG. 1) or a HEW STA 104 (FIG. 1). In accordance with embodiments, HEW device 1100 may include, among other things, a transmit/receive element 1101 (for example an antenna), a transceiver 1102, physical (PHY) circuitry 1104, and media access control (MAC) circuitry 1106. PHY circuitry 1104 and MAC circuitry 1106 may be HEW compliant layers and may also be compliant with one or more legacy IEEE 802.11 standards. MAC circuitry 1106 may be arranged to configure packets such as a physical layer convergence procedure (PLCP) protocol data unit (PPDUs) and arranged to transmit and receive PPDUs, among other things. HEW device 1100 may also include circuitry 1108 and memory 1110 configured to perform the various operations described herein. The circuitry 1108 may be coupled to the transceiver 1102, which may be coupled to the transmit/receive element 1101. While FIG. 11 depicts the circuitry 1108 and the transceiver 1102 as separate components, the circuitry 1108 and the transceiver 1102 may be integrated together in an electronic package or chip.

In some embodiments, the MAC circuitry 1106 may be arranged to contend for a wireless medium during a contention period to receive control of the medium for the HEW control period and configure an HEW PPDU. In some embodiments, the MAC circuitry 1106 may be arranged to contend for the wireless medium based on channel contention settings, a transmitting power level, and a CCA level.

The PHY circuitry 1104 may be arranged to transmit the HEW PPDU. The PHY circuitry 1104 may include circuitry for modulation/demodulation, upconversion/downconversion, filtering, amplification, etc. In some embodiments, the circuitry 1108 may include one or more processors. The circuitry 1108 may be configured to perform functions based on instructions being stored in a RAM or ROM, or based on special purpose circuitry. The circuitry 1108 may be termed processing circuitry in accordance with some embodiments. The circuitry 1108 may include a processor such as a general purpose processor or special purpose processor. The circuitry 1108 may implement one or more functions associated with transmit/receive elements 1101, the transceiver 1102, the PHY circuitry 1104, the MAC circuitry 1106, and/or the memory 1110.

In some embodiments, the circuitry 1108 may be configured to perform one or more of the functions and/or methods described herein and/or in conjunction with FIGS. 1-11 such as generating, receiving, and/or transmitting HE-SIG fields that indicate an allocation of the wireless medium to one or more HEW stations 104.

In some embodiments, the transmit/receive elements 1101 may be two or more antennas that may be coupled to the PHY circuitry 1104 and arranged for sending and receiving signals including transmission of the HEW packets. The transceiver 1102 may transmit and receive data such as HEW PPDU and packets that include an indication that the HEW device 1100 should adapt the channel contention settings according to settings included in the packet. The memory 1110 may store information for configuring the other circuitry to perform operations for configuring and transmitting HEW packets and performing the various operations to perform one or more of the functions and/or methods described herein and/or in conjunction with FIGS. 1-11 such as generating, receiving, and/or transmitting HE-SIG fields that indicate an allocation of the wireless medium to one or more HEW stations 104.

In some embodiments, the HEW device 1100 may be configured to communicate using OFDM communication signals over a multicarrier communication channel. In some embodiments, HEW device 1100 may be configured to communicate in accordance with one or more specific communication standards, such as the Institute of Electrical and Electronics Engineers (IEEE) standards including IEEE 802.11-2012, 802.11n-2009, 802.11ac-2013, 802.11ax, DensiFi, standards and/or proposed specifications for WLANs, or other standards as described in conjunction with FIG. 1, although the scope of the invention is not limited in this respect as they may also be suitable to transmit and/or receive communications in accordance with other techniques and standards. In some embodiments, the HEW device 1100 may use 4× symbol duration of 802.11n or 802.11ac.

In some embodiments, an HEW device 1100 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), an access point, a base station, a transmit/receive device for a wireless standard such as 802.11 or 802.16, or other device that may receive and/or transmit information wirelessly. In some embodiments, the mobile device may include one or more of a keyboard, a display, a non-volatile memory port, multiple antennas, a graphics processor, an application processor, speakers, and other mobile device elements. The display may be an LCD screen including a touch screen.

The transmit/receive element 1101 may comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result.

Although the HEW device 1100 is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The following examples pertain to further embodiments. Example 1 is an apparatus of a high-efficiency wireless local-area network (HEW) master station. The apparatus including circuitry configured to: transmit a high-efficiency (HE) signal (SIG) A (HE-SIG-A) field comprising common information to a plurality of HEW stations, wherein the HE-SIG-A is to be transmitted within a first sub-channel; and transmit a HE long-training field (HE-LTF) and a HE-SIG-B to a first HEW station of the plurality of HEW stations, where the HE-LTF and the HE-SIG-B are to be interleaved on subcarriers of a second sub-channel, where the HE-SIG-B comprises a first portion of station specific information for the first HEW station, and wherein the HE-LTF and the HE-SIG-B are to be transmitted in accordance with beamforming within the second sub-channel in accordance with orthogonal frequency division multi-access (OFDMA).

In Example 2, the subject matter of Example 1 can optionally include where the HE-SIG-A further comprises a second portion of station specific information for the first HEW station.

In Example 3, the subject matter of Examples 1 and 2 can optionally include where the first portion of station specific information comprises at least one from the group: an identification of the first HEW station, a modulation and coding scheme of a data portion for the first HEW station, a duration of a physical frame comprising the HE-SIG-A, HE-LTF, and HE-SIG-B, and an allocation of spatial streams to the first HEW station.

In Example 4, the subject matter of any of Examples 1-3 can optionally include where the HE-SIG-B comprises a HE-SIG-B1 and a HE-SIG-B2 and wherein the HE-SIG-B1 comprises the first portion of station specific information.

In Example 5, the subject matter of any of Examples 1-4 can optionally include where the circuitry is further configured to: transmit a HE-SIG-B2 symbol to the first HEW station, wherein the HE-SIG-B2 symbol comprises a third portion of station specific information for the first HEW station, and where the HE-SIG-B2 is to be transmitted in accordance with beamforming within the second sub-channel in accordance with orthogonal frequency division multi-access (OFDMA).

In Example 6, the subject matter of Example 5 can optionally include where the HE-SIG-B2 symbol does not include a second HE-LTF.

In Example 7, the subject matter of Example 6 can optionally include where the HE-SIG-B2 symbol further comprises a data portion for the first HEW station.

In Example 8, the subject matter of any of Examples 1-7 can optionally include where the second sub-channel is within the first sub-channel.

In Example 9, the subject matter of any of Example 1-8 can optionally include where the common information comprises one or more from the following group: a group identification of the HEW station, a number of spatial streams for the second sub-channel, a duration of a physical frame comprising the HE-LTF and a HE-SIG-B, an indication of a partition of the first sub-channel, an indication of a bandwidth of the second sub-channel, and an indication that a packet comprising the HE-SIG-A, HE-LTF, and HE-SIG-B is in accordance with Institute of Electrical and Electronic Engineers 802.11ax.

In Example 10, the subject matter of any of Examples 1-9 can optionally include where the circuitry is further configured to: transmit a HE short-training field (HE-STF), before the transmit the HE-LTF and the HE-SIG-B2, where the HE-STF is to be transmitted in accordance with beamforming within the second sub-channel.

In Example 11, the subject matter of any of Examples 1-10 can optionally include where the circuitry is further configured to: transmit data in accordance with beamforming within the second sub-channel.

In Example 12, the subject matter of Example 11 can optionally include where the first portion of information for the first HEW station comprises a modulation and coding scheme (MCS) for the data.

In Example 13, the subject matter of any of Examples 1-12 can optionally include where the HEW master station is one from the following group: a HEW station, a master station, an Institute of Electrical and Electronic Engineers (IEEE) access point, an IEEE 802.11ax master station, and a IEEE 802.11ax station.

In Example 14, the subject matter of any of Examples 1-13 can optionally include where the circuitry further comprises processing circuitry and transceiver circuitry.

In Example 15, the subject matter of any of Examples 1-14 can optionally include memory coupled to the circuitry; and, one or more antennas coupled to the circuitry.

Example 16 is a method performed on a high-efficiency wireless local-area network (HEW) master station. The method including transmitting a high-efficiency (HE) signal (SIG) A (HE-SIG-A) field comprising common information to a plurality of HEW stations, where the HE-SIG-A is to be transmitted within a first sub-channel; and transmitting a HE long-training field (HE-LTF) and a HE-SIG-B to a first HEW station of the plurality of HEW stations, where the HE-LTF and the HE-SIG-B are to be interleaved on subcarriers of a second sub-channel, where the HE-SIG-B comprises a first portion of station specific information for the first HEW station, and wherein the HE-LTF and the HE-SIG-B are to be transmitted in accordance with beamforming within the second sub-channel in accordance with orthogonal frequency division multi-access (OFDMA).

In Example 17, the subject matter of Example 16 can optionally include where the HE-SIG-B comprises a HE-SIG-B1 and a HE-SIG-B2 and wherein the HE-SIG-B1 comprises the first portion of station specific information.

Example 18 is an apparatus of a high-efficiency wireless local-area network (HEW). The apparatus including circuitry configured to: transmit a high-efficiency (HE) signal (SIG) A (HE-SIG-A) field comprising common information to a plurality of HEW stations, where the HE-SIG-A is to be transmitted within a first sub-channel; and transmit a plurality of HE-LTFs and a plurality of HE-SIG-B fields to the plurality of HEW stations, where the plurality of HE-LTFs are to be interleaved on subcarriers of a second sub-channel, and where each HE-SIG-B of the plurality of HE-SIG-B fields comprises station specific information for the corresponding HEW station of the plurality of HEW station, and wherein the HE-LTFs and the plurality of HE-SIG-B fields are to be transmitted in accordance with orthogonal frequency division multi-access (OFDMA).

In Example 19, the subject matter of Example 18 can optionally include where the plurality of HE-SIG-B fields are to be interleaved on the subcarriers of the second sub-channel with one another and with the plurality of HE-LTFs.

In Example 20, the subject matter of Examples 17 and 1 8 can optionally include where each of the plurality of HE-SIG-B fields are to be interleaved in a same pattern with the plurality of HE-LTFs in the frequency domain, and wherein each of the plurality of HE-SIG-B fields is to be transmitted on a separate spatial stream.

In Example 21, the subject matter of any of Examples 18-21 can optionally include where each of the plurality of HE-SIG-B fields are to be interleaved with the HE-LTFs in the frequency domain, and wherein each of the plurality of HE-SIG-B fields is to be transmitted on a separate spatial stream.

In Example 22, the subject matter of any of Examples 18-21 can optionally include where each of the plurality HE-LTFs are distributed on subcarriers distributed across at least one half a bandwidth of the second sub-channel.

In Example 23, the subject matter of any of Examples 18-22 can optionally include memory coupled to the circuitry; and, one or more antennas coupled to the circuitry.

Example 24 is a non-transitory computer-readable storage medium that stores instructions for execution by one or more processors of a high-efficiency (HE) wireless local-area network (WLAN) (HEW) master station. The operations to configure the one or more processors to cause the HEW master station to: transmit a high-efficiency (HE) signal (SIG) A (HE-SIG-A) field comprising common information to a plurality of HEW stations, wherein the HE-SIG-A is to be transmitted within a first sub-channel; and transmit a HE long-training field (HE-LTF) and a HE-SIG-B to a first HEW station of the plurality of HEW stations, wherein the HE-LTF and the HE-SIG-B are to be interleaved on subcarriers of a second sub-channel, wherein the HE-SIG-B comprises a first portion of station specific information for the first HEW station, and wherein the HE-LTF and the HE-SIG-B are to be transmitted in accordance with beamforming within the second sub-channel in accordance with orthogonal frequency division multi-access (OFDMA).

In Example 25,the subject matter of Example 24 can optionally include where the HE-SIG-B comprises a HE-SIG-B1 and a HE-SIG-B2 and wherein the HE-SIG-B1 comprises the first portion of station specific information.

The Abstract is provided to comply with 37 C.F.R. Section 1.72(b) requiring an abstract that will allow the reader to ascertain the nature and gist of the technical disclosure. It is submitted with the understanding that it will not be used to limit or interpret the scope or meaning of the claims. The following claims are hereby incorporated into the detailed description, with each claim standing on its own as a separate embodiment.

1. An apparatus of a high-efficiency (HE) master station, the apparatus comprising circuitry configured to:
transmit a HE (SIG) A (HE-SIG-A) field comprising common information to a plurality of HE stations, wherein the HE-SIG-A is to be transmitted within a first sub-channel; and
transmit a HE long-training field (HE-LTF) and a HE-SIG-B to a first HEW station of the plurality of HE stations, wherein the HE-LTF and the HE-SIG-B are to be interleaved on subcarriers of a second sub-channel, wherein the HE-SIG-B comprises a first portion of station specific information for the first HE station, and wherein the HE-LTF and the HE-SIG-B are to be transmitted in accordance with beamforming within the second sub-channel in accordance with orthogonal frequency division multi-access (OFDMA).

2. The apparatus of the HE master station of claim wherein the HE-SIG-A further comprises a second portion of station specific information for the first HE station.

3. The apparatus of the HE master station of claim 1, wherein the first portion of station specific information comprises at least one from the group: an identification of the first HEW station, a modulation and coding scheme of a data portion for the first HEW station, a duration of a physical frame comprising the HE-SIG-A, HE-LTF, and HE-SIG-B, and an allocation of spatial streams to the first HE station.

4. The apparatus of the HE master station of claim 1, wherein the HE-SIG-B comprises a HE-SIG-B1 and a HE-SIG-B2 and wherein the HE-SIG-131 comprises the first portion of station specific information.

5. The apparatus of the HE master station of claim wherein the circuitry is further configured to:
transmit a HE-SIG-B2 symbol to the first HE station, wherein the HE-SIG-B2 symbol comprises a third portion of station specific information for the first HE station, and wherein the HE-SIG-B2 is to be transmitted in accordance with beamforming within the second sub-channel in accordance with orthogonal frequency division multi-access (OFDMA).

6. The apparatus of the HE master station of claim 5, wherein the HE-SIG-B2 symbol does not include a second HE-LTF.

7. The apparatus of the HE master station of claim 6, wherein the HE-SIG-B2 symbol further comprises a data portion for the first HE station.

8. The apparatus of the HE master station of claim 1, wherein the second sub-channel is within the first sub-channel.

9. The apparatus of the HE master station of claim 1, wherein the common information comprises one or more from the following group: a group identification of the HE station, a number of spatial streams for the second sub-channel, a duration of a physical frame comprising the HE-LTF and a HE-SIG-B, an indication of a partition of the first sub-channel, an indication of a bandwidth of the second sub-channel, and an indication that a packet comprising the HE-SIG-A, HE-LTF, and HE-SIG-B is in accordance with Institute of Electrical and Electronic Engineers 802.11ax.

10. The apparatus the HE master station of claim 1, wherein the circuitry is further configured to:
transmit a HE short-training field (HE-STF), before the transmit the HE-LIT and the HE-SIG-B2, wherein the HE-STF is to be transmitted in accordance with beamforming within the second sub-channel.

11. The apparatus of the HE master station of claim 1, wherein the circuitry is further configured to:
transmit data in accordance with beamforming within the second sub-channel.

12. The apparatus of the HE master station of claim 11, wherein the first portion of information for the first HE station comprises a modulation and coding scheme (MCS) for the data.

13. The apparatus of the HE master station of claim 1, wherein the HEW master station is one from the following group: a HEW station, a master station, an Institute of Electrical and Electronic Engineers (IEEE) access point, an IEEE 802.11ax master station, and a IEEE 802.11ax station.

14. The apparatus of the HE master station of claim 1, wherein the circuitry further comprises processing circuitry and transceiver circuitry.

15. The apparatus of the HE master station of claim 1, further comprising memory coupled to the circuitry; and, one or more antennas coupled to the circuitry,

16. A method performed on a high-efficiency (HE) master station, the method comprising:
transmitting a HE signal (SIG) A (HE-SIG-A) field comprising common information to a plurality of HE stations, wherein the HE-SIG-A is to be transmitted within a first sub-channel; and
transmitting a HE long-training field (HE-LTF) and a HE-SIG-B to a first HEW station of the plurality of HE stations, wherein the HE-LTF and the HE-SIG-B are to be interleaved on subcarriers of a second sub-channel, wherein the HE-SIG-B comprises a first portion of station specific information for the first HE station, and wherein the HE-LTF and the HE-SIG-B are to be transmitted in accordance with beamforming within the second sub-channel in accordance with orthogonal frequency division multi-access (OFDMA).

17. The method of claim 16, wherein the HE-SIG-B comprises a HE-SIG-B1 and a HE-SIG-B2 and wherein the HE-SIG-B1 comprises the first portion of station specific information.

18. An apparatus of a high-efficiency (HE), the apparatus comprising circuitry configured to:
transmit a HE signal (SIG) A (HE-SIG-A) field comprising common information to a plurality of HE stations, wherein the HE-SIG-A is to be transmitted within a first sub-channel; and
transmit a plurality of HE-LTF and a plurality of HE-SIG-B fields to the plurality of HE stations, wherein the plurality of HE-LTFs are to be interleaved on subcarriers of a second sub-channel, and wherein each HE-SIG-B of the plurality of HE-SIG-B fields comprises station specific information for the corresponding HEW station of the plurality of HE station, and wherein the HE-LTFs and the plurality of HE-SIG-B fields are to be transmitted in accordance with orthogonal frequency division multi-access (OFDMA).

19. The apparatus of the HE master station of claim 18, wherein the plurality of HE-SIG-B fields are to be interleaved on the subcarriers of the second sub-channel with one another and with the plurality of HE-LTFs.

20. The apparatus of the HE master station of claim 18, wherein each of the plurality of HE-SIG-B fields are to be interleaved in a same pattern with the plurality of HE-LTFs in the frequency domain, and wherein each of the plurality of HE-SIG-B fields is to be transmitted on a separate spatial stream.

21. The apparatus of the HE master station of claim 18, wherein each of the plurality of HE-SIG-B fields are to be interleaved with the HE-LTFs in the frequency domain, and wherein each of the plurality of HE-SIG-B fields is to be transmitted on a separate spatial stream,

22. The apparatus of the HE master station of claim 18, wherein each of the plurality HE-LTFs are distributed on subcarriers distributed across at least one half a bandwidth of the second sub-channel.

23. The apparatus of the HE master station of claim 18, further comprising memory coupled to the circuitry; and, one or more antennas coupled to the circuitry.

24. A non-transitory computer-readable storage medium that stores instructions for execution by one or more processors of a high-efficiency (HE) master station, the operations to configure the one or more processors to cause the HEW master station to:
transmit a HE signal (SIG) A (HE-SIG-A) field comprising common information to a plurality of HE stations, wherein the HE-SIG-A is to be transmitted within a first sub-channel; and
transmit a HE long-training field (HE-LTF) and a HE-SIG-B to a first HEW station of the plurality of HE stations, wherein the HE-LTF and the HE-SIG-B are to be interleaved on subcarriers of a second sub-channel, wherein the HE-SIG-B comprises a first portion of station specific information for the first HE station, and wherein the HE-LTF and the HE-SIG-B are to be transmitted in accordance with beamforming within the second sub-channel in accordance with orthogonal frequency division multi-access (OFDMA).

25. The non-transitory computer-readable storage medium of claim 24, wherein the HE-SIG-B comprises a HE-SIG-B1 and a HE-SIG-B2 and wherein the HE-SIG-B1 comprises the first portion of station specific information.
